(19) United States
(12) Patent Application Publication
(10) Pub. No.: US 2025/0108815 A1
(43) Pub. Date: Apr. 3, 2025

(54) METHOD FOR INFLUENCING AN AGING PROCESS OF A COMPONENT OF AN EXHAUST AFTERTREATMENT SYSTEM FOR A VEHICLE, COMPUTER PROGRAM, CONTROL UNIT, DRIVING MACHINE, AND MOTOR VEHICLE

(71) Applicant: Volkswagen Aktiengesellschaft, Wolfsburg (DE)

(72) Inventor: Michael BIPPES, Braunschweig (DE)

(73) Assignee: Volkswagen Aktiengesellschaft, Wolfsburg (DE)

(21) Appl. No.: 18/902,039

(22) Filed: Sep. 30, 2024

(30) Foreign Application Priority Data
Sep. 29, 2023 (DE) 10 2023 209 630.7

(51) Int. Cl. B60W 50/038; B60W 40/12; B60W 50/00

(52) U.S. Cl. CPC B60W 50/038; B60W 40/12; B60W 2050/0088; B60W 2510/0657; B60W 2710/0666

(57) ABSTRACT

A method for influencing an aging process of a component of an exhaust aftertreatment system for a vehicle. An aging state of the component is predictively determined using an aging model. A characteristic value is determined from operating parameters from previous torque demands. An allowable torque is determined, taking into account the aging state of the component and the characteristic value at which a limit value of a compliant aging condition of the component is undershot. A current torque demand is compared with the allowable torque. A signal is issued if the current torque demand exceeds the allowable torque. A control command of a motor control unit is triggered. The control command being selected in the case of a deviation of the exceedance of the current torque demand from the allowable torque.

This nonprovisional application claims priority under 35 U.S.C. § 119 (a) to German Patent Application No. 10 2023 209 630.7, which was filed in Germany on Sep. 29, 2023, and which is herein incorporated by reference.

### BACKGROUND OF THE INVENTION

### Field of the Invention

The invention relates to a method for influencing an aging process of a component of an exhaust aftertreatment system for a vehicle, as well as to a computer program, a control unit, a driving machine, and a motor vehicle.

### Description of the Background Art

In order to comply with increasingly stringent exhaust gas legislation, various exhaust aftertreatment system (EAT) components are used to reduce pollutants. The combustion gases coming from the combustion chamber of the internal combustion engine can be cleaned in this way. The cleaning can be carried out mechanically, catalytically, or chemically.

However, the effectiveness of cleaning the exhaust gases depends largely on the state and the performance of the component. In addition, individual driving behavior has a significant influence on the aging of EAT components.

In the future, new legal regulations are intended to ensure that the pollutant emissions of vehicles are within a compliant range within a predefined relevant service life and that this range is not exceeded under any circumstances. It is therefore in the manufacturer's interest that the components for exhaust aftertreatment operate within the compliant range over the entire relevant service life and do not age too quickly. To this end, it is necessary that the components are negatively affected as little as possible by the driver's individual driving behavior.

In practice, driving conditions in which the EAT component operates outside the compliant range often occur in vehicles that have a high volume output or low output. Particularly at a low output, the driver increasingly requires a too high or almost maximum torque in order to be able to accelerate sufficiently when overtaking, for example. As a result, the components are overloaded and aging progresses more quickly. This ultimately has a direct negative impact on the performance of the components.

Various solution approaches are known in this regard. For example, oversized catalytic converters are installed, the performance of the vehicle is limited, components are replaced preventively, or the temperature in the EAT is increased while at the same time the exhaust gas volume flow is maintained.

The known solutions result in the problem that the installation space requirement increases, the time to reach the light-off temperature increases, the weight increases, the material costs increase, the fuel requirement increases, the mileage is reduced, or repair shop visits increase.

US 2012/0226424 A1 describes a method for determining the exhaust emissions and efficiency of a vehicle. A method for determining an emission flow rate of one or more CO2-equivalent gases from an exhaust system of an internal combustion engine of a vehicle is provided. Furthermore, a method for determining a vehicle efficiency factor of the vehicle is provided. The vehicle efficiency is compared in real time to the corresponding point on a vehicle efficiency map based on at least one of the following elements: current vehicle conditions, driving conditions, environmental conditions, or energy flow visualization data. A driver efficiency factor can be derived from this. Using these measures, the driver can track his vehicle's ecological footprint, compare emissions with standard emissions data, and optimize driving behavior. As a result, the driver can operate the vehicle more efficiently.

DE 10 2013 200 318 A1 describes a method for optimizing the fuel consumption of a vehicle drive train. By calibrating the drive train in the respective vehicle, fuel consumption can be reduced and emission regulations can be complied with simultaneously. The calibration is based on data collected during the journey. The data can comprise the aging status of exhaust aftertreatment components. The driver can be given driving instructions to reduce consumption. For example, an expected saving in the form of lower fuel consumption compared to the required investment can be calculated in advance for the driver to thus support the driver's decision.

AT 524043 A4 2022 Feb. 15 describes a method for the predictive control of a drive system of a motor vehicle. At least one piece of predictive information about the route is provided from the vehicle speed, traffic situation, topography, emission restriction, geofencing condition, weather condition, or visibility condition. To increase the service life of components, a model of the vehicle can be used in which the aging of a component of the vehicle is taken into account. As a result, for example, thermally stressed components can be kept within a target temperature range by means of heating or cooling measures.

### SUMMARY OF THE INVENTION

It is therefore an object of the present invention to provide an improved method for influencing an aging process of a component of an EAT, an improved computer program, an improved control unit, an improved driving machine, and an improved motor vehicle, in which the above-mentioned disadvantages are at least partially overcome.

In an example, a first aspect of the invention relates to a method for influencing an aging process of a component of an exhaust aftertreatment system (EAT) for a vehicle, comprising: predictively determining an aging state of the component using an aging model; determining a characteristic value from operating parameters from previous torque demands; determining an allowable torque, taking into account the aging state of the component and the characteristic value at which a limit value of a compliant aging condition of the component is undershot; comparing a current torque demand with the allowable torque; issuing a signal if the current torque demand exceeds the allowable torque; and triggering a control command of a motor control unit, wherein the control command is selected in a deviation of the exceedance of the current torque demand from the allowable torque.

The exhaust aftertreatment system component can be a catalytic converter. The catalytic converter can clean the vehicle's combustion gases mechanically, catalytically, or chemically. The component can be a particulate filter.

The aging process of multiple exhaust aftertreatment system components can be influenced with the method. Multiple components can be influenced at the same time. Multiple components can be influenced separately. Multiple components can be monitored or regulated at the same time with the method. For example, a control command can be triggered to influence the aging process of a specific component of the multiple components.

The aging state of the component can be predicted by the aging model.

The aging model can include the exhaust gas temperature. The aging model can include a temperature of the component. The exhaust gas temperature or the temperature of the component can be determined using sensors. The aging state of the component can correspond to a remaining residual activity of the component.

The characteristic value can be formed over time from the actual driving behavior. The characteristic value can be determined continuously. The characteristic value can take into account the driving behavior of the driver or the vehicle owner. The characteristic value can be determined continuously since the start of use. Current and past torque demands can be counted to determine the characteristic value. The characteristic value can include all previously determined torque demands. The torque demands can be load point-dependent.

The allowable torque can be the torque at which a limit value of the aging state can be maintained. The allowable torque can be a torque to be maintained temporarily so that the component can operate compliantly within the prescribed limit values over a specified service life. If the vehicle is operated below the allowable torque, the performance of the component can be guaranteed within this specified service life. The specified service life may be a legally prescribed period. The specified service life can be a life cycle of the component or the vehicle.

The limit value of the compliant aging condition can include a legal limit value. The method can be used to influence the aging process in such a way that the limit value is not exceeded over the entire service life.

The current torque demand can be a driver's request. The current torque demand can be a driver's desired torque.

A signal can be issued if it becomes apparent that the component cannot reach the limit value of the compliant aging condition over the specified service life while maintaining the current torque demand.

The signal can trigger a control command. The control command can help in selecting a torque demand that differs from the current torque demand so that the allowable torque is not exceeded. The component can be preserved thereby. This can influence the aging process of the component.

The control command can be an action. The control command can be selected depending on the deviation of the exceedance. The control command can be selected from multiple available control commands.

The driver can be actively informed about driving behavior in this way. The driver can be shown his influence on the performance of the component depending on his driving behavior. The driver can be actively involved and contribute to slowing down the aging process of the component with his driving behavior. This results in the effect that the exhaust aftertreatment system component can operate in compliance with limit values over its entire service life.

A component for the exhaust aftertreatment system that does not have to be oversized can be used due to the method. Material, weight, and installation space can be saved as a result. The component can achieve a higher performance due to the method. The pollutant emissions during the driving operation can be reduced thereby.

The control command can be selected differently according to the deviation of the exceedance.

Various control commands can be available, which are selected according to the deviation of the exceedance. The control command can be graded differently depending on the urgency of complying with the limit value. The control command can be different with an increased urgency of complying with the limit value. The control command can be selected differently for a small deviation from the allowable torque than for a greater deviation from the allowable torque. The control command can be selected differently depending on the current aging state of the component. The control command can be selected differently depending on the progressive aging state of the component. The control command can be an information display for the driver. The control command can be an intervention in the motor control. The control command can be a storage of data or information. The control command can be a combination of these.

The data can be stored within the vehicle. The data can be saved in a different location. The different location can be a control center or collection point. The different location can be a vehicle manufacturer's system, a repair shop, or a government facility.

In a case in which the vehicle is, for example, a hybrid vehicle, the control command can regulate a load distribution between a combustion engine and an electric drive. The control command can, for example, specify a certain battery state of charge (SoC). As a result of the control command, the electric drive can be activated so that the aging process of the component is reduced. Switching to the electric drive can take place, for example, within a section in which the EAT component is subjected to particularly high loads.

The control command can be selected and triggered according to an actual need or urgency for complying with the limit values. In this way, the aging process can be influenced in such a way that the performance of the component is guaranteed within the specified service life.

Also, the control command can be an action recommendation to maintain the allowable torque.

The action recommendation can be no action. The action recommendation can be a recommendation. The action recommendation can be a message to the driver. The action recommendation can be made via a vehicle-side device. The vehicle-side device can be a display, a loudspeaker, and/or a warning light. The message can also be sent telemetrically to the driver via a predetermined wireless transmission system to a computer unit. The computer unit can be a cell phone, a smartphone, a tablet, a smartwatch, or an AR wearable device, for example.

The action recommendation can be an entry in an error memory. The action recommendation can be a recommendation of the torque demand to the driver. The action recommendation can be a recommendation for a different route. The action recommendation can be a recommendation for a different travel time. The action recommendation can be a recommendation to use a different fuel. The action recommendation can be the request for vehicle-side support in implementing an action to maintain the performance of the exhaust aftertreatment system component. The action recommendation can be an indication of an increased future consumption of fuel and other operating materials, in particular reducing agents and/or engine oil. The action recommendation can be an indication of the increase in CO2 and/or pollutant emissions from the driving behavior and/or from a replacement of components of an exhaust (partial) system.

The action recommendation can be a question to the driver as to whether he wants to continue to be supported with notifications. If yes, the frequency and type of notification can be defined. If no, such a request can still be made again after a rest period.

The action recommendation can include whether the vehicle should support the driver by dynamically and/or statically adjusting, in particular reducing, the current torque demand in order to achieve the driving states that are favorable for the component to prevent aging. In this case, the action recommendation can include offering the driver this support only within a certain time frame or a certain performance range.

The action recommendation can include sending the driver an evaluation of his journey at the end of the journey with information on driving states that are detrimental to the aging state of the component. The transmission can be carried out using a map or map display, for example.

The action recommendation can include informing the driver of an upcoming driving situation in good time before the corresponding driving situation occurs in the case of a determined repeated route. In this regard, the driver can be offered support measures and advice. The determined repeated routes can be, for example, the way to work or the way home.

In this way, the driver can be actively informed about his driving behavior. The driver can be shown his influence on the performance of the EAT as a function of his driving behavior. By actively involving the driver, the performance of the EAT can be maintained longer. By actively involving the driver, the aging process of the component can be slowed down. The CO2 and pollutant emissions during driving can be reduced by the driver's involvement. The replacement of components can be avoided and maintenance costs reduced by the driver's involvement. The replacement of components can be avoided or reduced by a driving state or torque adapted to the premature aging of the component.

Also, the control command can issue a torque demand that differs from the current torque demand in order to fall below the allowable torque.

The deviating torque demand can be a recommendation. The deviating torque demand can be an intervention. The intervention can be an automatic intervention. The deviating torque demand can be an intervention in the driving machine. In a case in which it becomes apparent that the performance of the component would no longer be maintained over the specified period of use if the current torque demand is continued, a different torque demand can be selected automatically. At the same time, the driver can be shown an action recommendation.

The control command can be the automatic limitation of the current torque demand. The control command can be the automatic limitation of a torque request on the part of the driver. The deviating torque demand can be a torque of zero, therefore, the prevention of a start and/or departure. For example, the departure prevention can be active until a light-off temperature of the component is reached.

This can prevent the vehicle from being operated in a state in which the performance of the component is no longer possible during its entire service life.

The aging model for determining the aging state can include a component's mileage achieved at the time of the determination and/or a mileage remaining at the time of the determination. The aging model can include further parameters. The aging model can include environmental parameters.

Each component can have a specified maximum mileage. The maximum mileage can be derived from the manufacturer's specifications. The mileage can be determined, for example, via a mileage of the vehicle.

The aging model for determining the aging state can include the component's mileage achieved at the time of the determination. The aging model can include any mileage remaining at the time of the determination. The aging state can be calculated from their sum. The aging state can be formed from their ratio. The aging state can be calculated from the ratio to the actually achieved or remaining mileage.

This makes it possible to determine the extent to which the driving behavior influences the residual activity of the EAT component. Furthermore, it can be determined whether the current driving behavior could cause the component to fall below its compliant aging condition before the end of the relevant service life.

The aging model can be used to predict how driving behavior influences which EAT component is affected and how. The influence can be negative or positive. The aging model can be used to determine predictively the aging state before, during, and after a driving phase.

There are examples in which an environmental parameter is included to determine the allowable torque.

The environmental parameters can be an ambient temperature. The environmental parameter can be an ambient pressure. The environmental parameter can be an air humidity. The environmental parameter can be a particle pollution of the environment. The environmental parameter can be a pollutant load in the environment. The environmental parameter can comprise the fuel used. The environmental parameter can comprise the engine oil used. The environment parameter can comprise multiple parameters. The environmental parameter can be determined from sensor data.

In this way, the allowable torque can be adapted to the current conditions. As a result, it can be taken into account that the environmental parameters may influence the aging process of the component.

The previous torque demands can be the torque demands in an operating period of the vehicle.

The operating period can correspond to the previous mileage of the vehicle. The previous torque demands can have been counted within the operating period. A change of ownership can justify a new or a further operating period.

Multiple characteristic values can be determined and one of the multiple characteristic values can be included in determining the allowable torque.

Each of the multiple characteristic values can be assigned to a different driver. Each characteristic value can be assigned to its own driver profile. For example, a driver can be assigned via another personalized key, a cell phone, or a driver query at the start of the journey.

Every driver has an individual driving style. This can result in a different characteristic value for each driver. The allowable torque can be different for each driver in the case of a different characteristic value. This can result in a different control command being triggered for a driver with a more sporty driving style than for a driver with a more defensive driving style.

The current torque demand can be determined from an accelerator pedal position and/or from driving data.

The current torque demand can be determined from an accelerator pedal position. The current torque demand can be determined from driving data. The driving data can be navigation data. For example, the driver can enter navigation data before starting a journey. An optimal route can be determined from the navigation data so that the EAT component is stressed as little as possible. Furthermore, the navigation data can be used to determine in advance critical sections of the route where the allowable torque may be exceeded. Based on this knowledge, a corresponding control command can be triggered before the start of a journey or during the journey. The control command can be an action recommendation for the driver on how he must drive the vehicle so that the component is stressed as little as possible.

In a case where the vehicle is a hybrid vehicle, a control command can be triggered as to when the vehicle should be operated via the combustion engine and when via the electric motor.

In another case, in which the vehicle is to be operated autonomously, a control command can be triggered that issues different torques for different route sections in which the torque does not fall below the allowable torque.

A regeneration of the component can be carried out when the current torque demand fulfills a criterion for the regeneration.

The regeneration can be a regeneration cycle. The service life of the component can be extended by the regeneration. The criterion can be met if the vehicle has to be driven for a minimum period of time or a minimum distance. For example, it can be determined from the driving data whether the criterion for the regeneration is met for the component in a previous journey. If the criterion is met, the regeneration is carried out. If the criterion is not met, no regeneration is carried out.

The regeneration can influence the aging process of the component. The regeneration can influence the performance of the component. The regeneration can influence the aging state of the component.

A second aspect of the invention relates to a computer program which can be loaded directly into a memory of a control unit, with a program for carrying out the steps of the method of the invention when the program is executed in the control unit. The computer program comprising commands which, when the program is executed by a computer, can cause the computer to execute the method of the invention,

A third aspect of the invention relates to a control unit which is set up to execute the method of the invention.

A fourth aspect of the invention relates to a driving machine. The driving machine can be controlled via the control unit of the invention. The driving machine is set up and designed to carry out the method of the invention.

The driving machine can comprise an internal combustion engine with an exhaust aftertreatment system. The internal combustion engine can be a gasoline engine. The internal combustion engine can be a diesel engine. The driving machine can comprise a hybrid drive. The hybrid drive can comprise the internal combustion engine and an electric motor. The driving machine can comprise a fuel cell drive with a corresponding exhaust aftertreatment system.

A fifth aspect of the invention is a motor vehicle with the control unit of the invention. The motor vehicle is set up and designed to carry out the method of the invention.

The vehicle can be a motor vehicle. The vehicle can be a watercraft. The vehicle can be a rail-bound vehicle.

The method of the invention can also be used in any other system which has a combustion unit for providing power and/or heat and has an exhaust aftertreatment system.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows an internal combustion engine with an exhaust aftertreatment component and a control unit;

FIG. 2 schematically shows a sequence for triggering a control command;

FIG. 3 schematically shows a flowchart of a method according to an example;

FIG. 4a schematically shows an exemplary flowchart for determining the aging load;

FIG. 4b schematically shows an exemplary flowchart of a counter for determining the aging load; and

FIG. 5 schematically shows a motor vehicle with a control unit according to an example.

### DETAILED DESCRIPTION

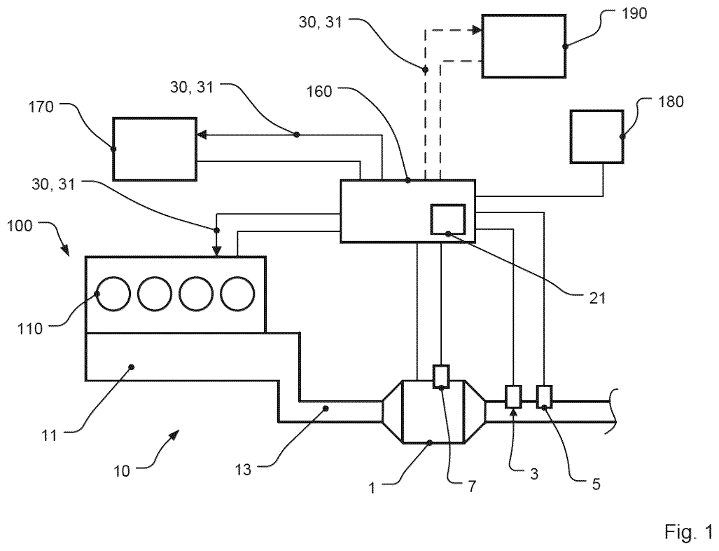

FIG. 1 shows a schematic view of a driving machine 100 with an internal combustion engine 110 and a control unit 160. Internal combustion engine 110 is connected with its outlet 11 to an exhaust system 10, which comprises an exhaust duct 13. A component 1 of the exhaust aftertreatment system is arranged downstream in the exhaust duct.

A temperature sensor 5 and a mass flow sensor arrangement 3 are arranged downstream of component 1 in exhaust system 10. Temperature sensor 5 and mass flow sensor arrangement 3 are used to determine a current exhaust gas temperature and a current exhaust gas mass flow. Mass flow sensor arrangement 3 can comprise two sensors. A flow rate and/or a density can be determined with the sensors. A further temperature sensor 7 is arranged on component 1 to determine a temperature at component 1.

Further, temperature sensors and mass flow sensors can also be arranged upstream before component 1 for monitoring.

Control unit 160 is shown furthermore in FIG. 1. Control unit 160 includes aging model 21, among other things. Control unit 160 is connected to component 1, driving machine 100, a display unit 170, a transmission unit 190, and a database 180. Furthermore, control unit 160 is connected to temperature sensors 5 and 7 as well as to mass flow sensor arrangement 3. Display unit 170 is located in the driver's field of vision.

For example, various characteristic values 23 or other parameters can be accessed via database 180.

FIG. 1 shows a state in which a signal 30 is issued and a control command 31 is triggered. In FIG. 1, as an example, signal 30 with control command 31 is issued and triggered to driving machine 100, display unit 170, and transmission unit 190. Signal 30 with control command 31 can also be issued and triggered only to driving machine 100, display unit 170, or transmission unit 190.

Transmission unit 190 is connected to control unit 160 via a dashed line, because the output can take place inside or outside the vehicle. The transmission can be wireless.

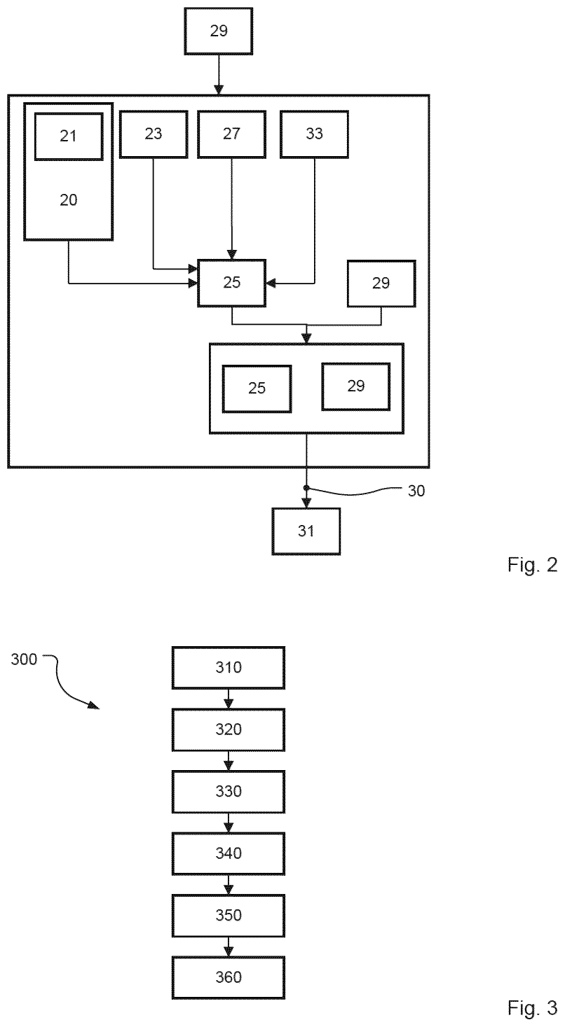

FIG. 2 schematically shows a sequence for triggering control command 31. The input variable is a current torque demand 29. Allowable torque 25 is determined taking into account an aging state 20 of component 1 with an aging model 21, a characteristic value 23, a limit value 27 of a compliant aging condition of component 1, and an environmental parameter 33. The current torque demand 29 is then compared with allowable torque 25. In FIG. 2, the current torque demand 29 exceeds allowable torque 25. In this sequence, a signal 30 is issued which triggers a control command 31.

FIG. 3 shows a flowchart of a method 300 for influencing an aging process of component 1 of the exhaust aftertreatment system according to an example.

In block 310, aging state 20 of component 1 is predictively determined using aging model 21.

In block 320, characteristic value 23 is determined from operating parameters from previous torque demands.

In block 330, the allowable torque 25 is determined taking into account aging state 20 of component 1 and characteristic value 23. The allowable torque 25 is a torque at which the value falls below limit value 27 of a compliant aging condition of component 1.

In block 340, the current torque demand 29 is compared with the allowable torque 25.

In block 350, signal 30 is issued if the current torque demand 29 exceeds the allowable torque 25.

Control command 31 is triggered in block 360. The selection of control command 31 is made depending on a deviation of the exceeding of the current torque demand 29 from the allowable torque demand 25.

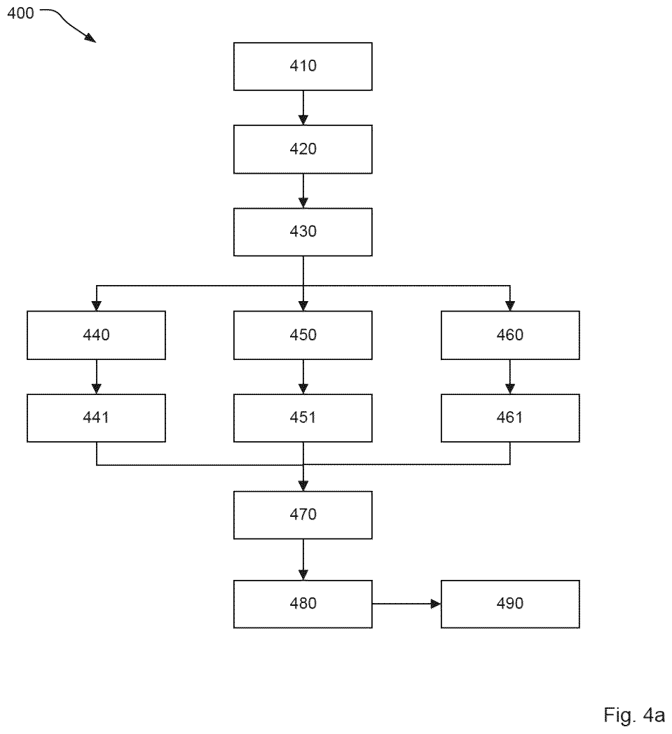

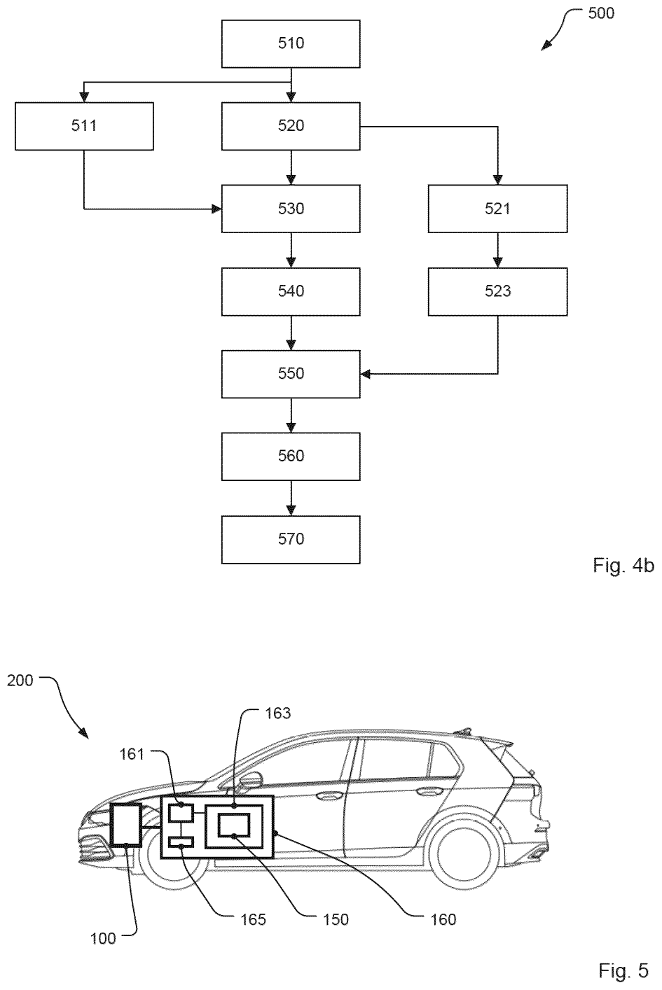

FIG. 4a shows an exemplary flowchart 400 from a torque demand as an input variable to the issuing of a control command 31.

Block 410 is a torque demand coming from a driver as an input variable. The torque demand can correspond to the current torque demand 29.

Block 420 comprises control unit 160. Control unit 160 is an ECU. The torque demand is transmitted from block 410 to block 420.

In block 430, a torque is provided to driving machine 100. The control unit provides the torque to driving machine 100. The torque can be provided to internal combustion engine 110.

In turn, three blocks 440, 450, and 460 are output from block 430 in three parallel paths.

In the first path, the exhaust gas temperature and the exhaust gas mass flow are measured in block 440. The exhaust gas temperature can be measured via temperature sensor 5. The exhaust gas mass flow can be measured via mass flow sensor arrangement 3.

In the first path, a load point-dependent evaluation of the aging load is then carried out in block 441. The evaluation occurs on the basis of the measurement results from block 440.

In the second path, a predictive determination of the exhaust gas temperature and a predictive determination of the exhaust gas mass flow are carried out in block 450. The predictive determination can be made using aging model 21.

In the second path, a load point-dependent evaluation of the aging load is then carried out in block 451. The evaluation occurs on the basis of the predictively determined values from block 440.

In the third path, the torque demands are counted in block 460. This is done via a counter. The counting of the torque demands can occur depending on the load point. The counting of the torque demands contributes to the determination of characteristic value 23.

In the third path, the torque demands are then compared with a threshold value in block 461.

The three paths merge back into a single path in block 470. The various evaluations are compared with each other in block 470.

A comparison with default values is then carried out in block 480. The default values can be limit values.

Finally, a signal 30 is issued in block 490. Signal 30 triggers a control command 31. The control command is a notification to the driver or a restriction of the torque demand.

FIG. 4b shows an exemplary flowchart 500 of a counter. The counter in FIG. 4b can be implemented in the flowchart 400 of FIG. 4a.

A torque demand is used as the input variable in block 510.

The torque demand from block 510 enters into block 520 and in parallel into block 511.

A driving situation is determined in block 520. The driving situation is determined from the torque demand.

An exhaust aftertreatment situation is determined in block 511 arranged in parallel.

The determined driving situation from block 520 and the determined exhaust aftertreatment situation from block 511 enter into block 530. In block 530, an allowable torque is determined from the viewpoint of an aging load.

The allowable torque is then compared in block 540 from the viewpoint of the aging load. The allowable torque can be compared with the requested torque.

The determined driving situation from block 520 enters in a parallel path into block 521 next to block 530. A timeout is determined in block 521. The timeout can be a time at which the torque demand is too high.

The overruns are then weighted with time in block 523.

The weighted time overruns from block 523 and the comparison of the allowable torque from the viewpoint of the aging load from block 540 then enter into block 550. In block 550, the demand situations that exceed the allowable torque are counted.

The overruns are then evaluated in block 560. The evaluation is carried out, for example, according to the driving situation or the torque demand.

Finally, a control command 31 is triggered in block 570. Control command 31 can be an action with a notification of the driver.

Finally, FIG. 5 schematically shows an exemplary control unit 160, which is set up to carry out the method described above. Control unit 160 is arranged in a motor vehicle 200 and can control and/or regulate driving machine 100 with internal combustion engine 110. Control unit 160 comprises a processor 161, a memory (electronic storage medium) 163, and an interface 165. Further, a computer program (software) 150, which is designed to carry out the method described above using the program, is also stored in memory 163. Processor 161 is designed to execute program instructions of computer program 150. Interface 165 is designed further to receive and transmit data. For example, it may be an interface to a CAN bus of motor vehicle 200, via which control unit 160 receives signals and transmits control commands.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for influencing an aging process of a component of an exhaust aftertreatment system for a vehicle, the method comprising:
predictively determining an aging state of the component using an aging model;
determining a characteristic value from operating parameters from previous torque demands;
determining an allowable torque, taking into account the aging state of the component and the characteristic value at which a limit value of a compliant aging condition of the component is undershot;
comparing a current torque demand with the allowable torque;
issuing a signal if the current torque demand exceeds the allowable torque; and
triggering a control command of a motor control unit, the control command being selected in the case of a deviation of the exceedance of the current torque demand from the allowable torque.

2. The method according to claim 1, wherein the control command is selected differently according to the deviation of the exceedance.

3. The method according to claim 1, wherein the control command is an action recommendation to maintain the allowable torque.

4. The method according to claim 1, wherein the control command issues a torque demand that differs from the current torque demand in order to fall below the allowable torque.

5. The method according to claim 1, wherein the aging model for determining the aging state comprises a mileage of the component achieved at the time of the determination and/or a mileage remaining at the time of the determination.

6. The method according to claim 1, wherein an environmental parameter is included to determine the allowable torque.

7. The method according to claim 1, wherein the previous torque demands are the torque demands in an operating period of the vehicle.

8. The method according to claim 1, wherein multiple characteristic values are determined and one of the multiple characteristic values is included in determining the allowable torque.

9. The method according to claim 1, wherein the current torque demand is determined from an accelerator pedal position and/or from driving data.

10. The method according to claim 1, wherein a regeneration of the component is carried out when the current torque demand fulfills a criterion for the regeneration.

11. A computer program adapted to be loaded directly into a memory of a control unit, to perform the steps of the method according to claim 1 when the program is executed in the control unit.

12. A control unit adapted to execute the method according to claim 1.

13. A driving machine comprising a control unit according, the driving machine is set up and designed to carry out the method according to claim 1.

14. A motor vehicle comprising a driving machine, wherein the motor vehicle is set up and designed to carry out the method according to claim 1.
